(19) United States
(12) Patent Application Publication
(10) Pub. No.: US 2011/0220435 A1
(43) Pub. Date: Sep. 15, 2011

(54) Sound Absorbing Device

(76) Inventor: Stephen Dance, London (GB)

(21) Appl. No.: 13/114,732

(22) Filed: May 24, 2011

Related U.S. Application Data
(63) Continuation of application No. 12/505,138, filed on Jul. 17, 2009, now abandoned.

(30) Foreign Application Priority Data
Jul. 17, 2008 (GB) 0813106.2

(51) Int. Cl. E04B 1/84; B23P 11/00

(52) U.S. Cl. 181/294; 29/428

(57) ABSTRACT

An optically reflective sound absorbing device (13) comprising a sound absorbing structure (25), and a non-porous optically reflective sound transfer medium (17) that is configured and arranged to transfer sound waves incident on the sound transfer medium (17) to the sound absorbing structure (25) for absorption thereby.

### CROSS REFERENCE TO RELATED APPLICATIONS

The present application claims priority to United Kingdom Patent Application No. 0813106.2 filed Jul. 17, 2008, the disclosure of which is incorporated herein by reference in its entirety.

### FIELD OF THE INVENTION

This invention relates to sound absorbing devices. In one illustrative embodiment, such devices include a tensioned non-porous membrane. One particularly preferred embodiment relates to sound absorbing devices that are configured as mirrors for use by musicians whilst playing instruments.

### BACKGROUND TO THE INVENTION

In April 2008 existing UK legislation protecting workers in the music and entertainment sectors from exposure to excessive noise were replaced by the Control of Noise at Work Regulations 2005 (Noise Regulations). Although the European Directive (2003/10/EC) on which these regulations are based came into force for other industry sectors in 2006, the music and entertainment sectors were provided with two year's grace on account of the fact that making music is legislatively unusual in that the “noise” is typically deliberately created for enjoyment.

The regulations set out practical guidelines for helping workers, employers and freelancers in the music and entertainment sectors to protect their hearing and hence safeguard their careers. In particular the regulations dictate that employers must provide hearing protection and set up hearing protection zones for workers who are subject to noise levels of 85 decibels or more (daily or weekly average exposure). The legislation also provides that employers must assess the risk to workers' health and provide them with information and training in the event that they are exposed to noise levels of 80 dB or more, and that workers must not be exposed to noise in excess of 87 dB (due account having been taken of any reduction in exposure provided by hearing protection).

For professional musicians; particularly those who play noisier instruments such as percussion, brass or wind instruments; the advent of these regulations has meant that many musicians have had to look again at the way that they practice playing their instruments.

Hitherto it has been commonplace for professional musicians to practice their instruments, typically for many hours a day, in small cell-like rooms that are acoustically insulated to a greater or lesser extent from neighbouring practice rooms. Conventionally the interior walls of these rooms are quite reflective to sound so that the musicians can hear and critique the music they are making. In addition, when instrument sections practice in a rehearsal room, it is often the case that at least one entire wall of the room is covered with a conventional mirror.

Whilst such an arrangement is advantageous from the point of view of providing the musician with an acoustically realistic environment that faithfully presents the music to them, it is disadvantageous in that much of the sound generated by the musician is reflected back at them, thereby exposing the musician to potentially harmful levels of sound.

This problem is further compounded by the fact that many musicians like to practice their instruments in front of a mirror (for example, a full-length mirrored sheet of glass) so that they can not only hear the sound they are making, but also see the way they are playing the instrument. Whilst playing in front of a mirror is a good way for a musician to visually critique their performance, it is not so beneficial from an acoustic point of view because the mirror provides a hard surface that reflects much of the sound generated by the musician's instrument back at the musician. This problem is particularly apparent for musicians playing brass instruments because the sound that is generated emanates from the bell of the instrument and is therefore directly incident on the mirror (and hence strongly reflected) when the musician plays their instrument in front of it.

One way of mitigating the problem of high sound levels is to provide musicians with earplugs or ear defenders that are to be worn whilst practicing. However, whilst the wearing of such devices does reduce the musician's exposure to sound, it is not a popular proposition because the wearing of earplugs or ear defenders necessarily deadens the sound, in some instances to such an extent that subtleties of the music can no longer be appreciated. This is particularly a problem when a group of musicians are playing together and it is necessary for one musician to be able to hear what the other musicians are playing so that they can join in at the correct time, and also for conductors or instructors who need to be able to hear the subtleties of the music being played.

It is also the case that good quality custom made musicians' ear plugs are relatively expensive to purchase, and that it is in any case very difficult for employers to ensure that employees comply with their employer's instructions to wear such protective devices.

Another proposal for mitigating such problems is to adapt the interior walls of the practice rooms so that they act less to reflect sound and more to absorb or disperse sound. Whilst such an approach does effectively reduce ambient noise levels within the room, it is prohibitively expensive to retrofit existing practice rooms with appropriate sound absorbing or dispersing structures. It is also the case that as such structures tend to destroy the natural sound of the music; they are not popular with musicians who need to be provided with a faithful reproduction of the music so that they can effectively critique their performance.

The problem of effectively reducing sound levels is, of course, not limited to providing musicians with the ability to make music without seriously damaging their hearing. More generally, it is often desirable when refurbishing rooms of existing buildings or constructing new buildings that are to be used for relatively noisy purposes to specify that certain walls of those buildings are constructed so as to reduce ambient noise levels within the rooms. Typical sound absorbing devices are often designed to be mounted to a conventional wall and hence often require that wall to be penetrated by fixings to hold the sound absorbing device in place. It is often the case that the materials used for internal walls are carefully chosen, for example by an architect, to provide a desired visual effect, and as a result there is often resistance to having those materials penetrated. One option for avoiding this problem is to specify that internal walls should be constructed from porous material to permit sound to travel through the outer surface of the wall for absorption by sound absorbing material provided within the wall, but such material is generally unpopular as it has a relatively poor outward appearance.

The present invention has been conceived with the aim of addressing one or more of the aforementioned problems.

### SUMMARY OF THE INVENTION

To this end, a presently preferred embodiment of the present invention provides a sound absorbing device that comprises a sound absorbing structure, and a non-porous sound transfer medium that is configured and arranged to transfer incident sound waves to the sound absorbing structure for absorption thereby. The sound transfer medium may, in one illustrative embodiment, be optically reflective so that the sound absorbing device is configured as a mirror.

An advantage of this embodiment is that it provides a relatively inexpensive way of reducing ambient sound levels without having to penetrate the existing wall structure.

It is also the case that the provision of a mirror constructed in accordance with a preferred embodiment of the present invention is a much less expensive proposition than retrofitting existing practice chambers with appropriate sound absorbing or dispersing structures, and tends to have much less of an effect on the natural sound of the music generated.

A further advantage associated with this embodiment that is particularly apparent for musicians playing brass instruments is that as much of the sound incident on the mirror surface tends to come directly from the instrument rather than by reflection from the internal walls of the practice room, absorbing at least part of this directly incident sound can provide a greater reduction of ambient sound levels within the room than an arrangement where reflected sound is absorbed, for example by a sound absorbing wall covering. Furthermore, as a mirror according to a preferred embodiment typically does not cover the entire internal surface of a wall on which it is hung, the most widely dispersed components of the sound generated by the instrument tend not to be incident on the mirror and are therefore not absorbed. These widely dispersed components continue to be reflected by the internal wall of the practice room thereby better preserving the natural spatial characteristics of the generated sound.

In a preferred arrangement, the sound transfer medium is configured to vibrate in response to incident sound waves. The sound transfer medium may be configured to be responsive to sound waves having a frequency of 250 Hz to 2 kHz.

In a preferred embodiment the sound absorbing structure comprises fibrous sound absorbing material. The fibrous sound absorbing material may comprise a body consisting of a plurality of intertwined fibres. The sound absorbing material may comprise a mineral wool (for example, rock wool).

In a particularly preferred arrangement the sound absorbing structure and sound transfer medium are spaced from one another. For example the sound absorbing structure and sound transfer medium may be spaced from one another by about 1 to 5 mm.

In one embodiment, the fibrous sound absorbing material has a generally planar surface, and the spacing between the sound absorbing structure and sound transfer medium is such that at least some fibres that are upstanding from said generally planar surface bear against the sound transfer medium to locally damp vibrations in said medium.

The sound absorbing device may comprise a frame for supporting said sound transfer medium The frame may be configured so as to reduce that the area of frame that is in contact with the sound transfer medium. For example, the sound transfer medium may be configured to bear upon projections that extend beyond an upper surface of peripheral components of the frame. In another arrangement, peripheral components of the frame may be inclined towards the centre of the sound absorbing device so that only an edge portion of the peripheral components of the frame contacts the sound absorbing structure. The sound absorbing device may comprise a backing that is securable to said frame. The backing may comprise means for supporting the sound absorbing structure. The supporting means may comprise a plurality of fixings (for example pins, nails or screws) extending from a face of the backing, the arrangement being such that the sound absorbing structure can be impaled on the fixings to affix the sound absorbing structure to the backing.

In a particularly preferred embodiment the frame and backing are configured and arranged so that a sound absorbing structure supported by the backing is spaced from a sound transfer medium affixed to the frame by about 1 to 5 mm when the backing is secured to the frame.

The sound transfer medium may comprise a film, for example an optically reflective film. The film may be less than 150 microns thick. In another embodiment, the film may be less than 120 microns thick. In yet another embodiment the film may be between 60 to 100 microns thick.

In a preferred arrangement the film may be shrinkable to tension the film. In an embodiment where the film is reflective, the film may be shrinkable to provide substantially specular reflectivity. The film may be shrinkable in response to the application of heat. For example, the film may be shrinkable in response to heat at a temperature of 150 to 200 degrees centigrade.

In one embodiment the film may comprise a plurality of layers. The multilayer film may comprise an optically reflective layer. The film may comprise a removable protective layer that protects said reflective layer. The film may comprise an adhesive layer provided on one side of said optically reflective layer. The film may comprise a removable protective layer that protects said adhesive layer. In an illustrative embodiment, the film may comprise a metallised polymer composite.

In another embodiment the film may comprise a carrier that has been coated to render it optically reflective. The coating may be applied after the carrier has been secured to the frame, or before it has been secured to the frame. The coating may be applied to the carrier after it has been tensioned on the frame or before it has been tensioned on the frame.

Another embodiment of the present invention provides a sound absorbing device comprising: a backing that comprises means for supporting a sound absorbing structure; a sound absorbing structure mounted on said support means; a frame affixed to the backing; and a tensioned film carried by the frame; wherein the frame is configured so that the tensioned film is spaced from the sound absorbing structure by about 1 to 5 mm, and the film is configured to transfer sound waves incident on the film to the sound absorbing structure for absorption thereby. In one aspect of this embodiment, the sound absorbing device may comprise a mirror, and the tensioned film may be optically reflective. In this embodiment the film may be tensioned so as to provide substantially specular reflection.

Yet another embodiment of the present invention provides a method of making a sound absorbing device, the method comprising: providing a sound absorbing structure and a non-porous sound transfer medium; and arranging the sound absorbing structure and sound transfer medium so that sound waves incident on the sound transfer medium are transferred to the sound absorbing structure for absorption thereby.

One further embodiment of the present invention provides: a method of making a sound absorbing device, the method comprising: providing a backing; affixing means for supporting a sound absorbing structure to said backing; providing a frame; fixing said frame to said backing so that said sound absorbing structure is located within a boundary defined by the frame and recessed from a surface of the frame opposite that to which the backing is fixed; affixing a non-porous sound transfer medium to at least a peripheral part of said surface of the frame, and tensioning said sound transfer medium on the frame; wherein the frame is configured so that the sound transfer medium is spaced from the sound absorbing structure affixed to the backing, the arrangement being such that the sound transfer medium can transfer incident sound waves to the sound absorbing structure for absorption thereby.

As will be appreciated by persons skilled in the art, the various elements of the method aforementioned need not be carried out in the order specified. For example the frame could be affixed to be backing before the means for supporting the sound absorbing structure is affixed to the backing.

Other features, advantages and embodiments of the present invention will be apparent from the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic representation of a musician playing an instrument in a music practice room that is equipped with a conventional mirror;

FIG. 2 is a schematic representation of a musician playing an instrument in a music practice room that is equipped with a sound absorbing device according to a preferred embodiment of the present invention;

FIG. 3 is a perspective view of a sound absorbing device according to a preferred embodiment of the present invention;

FIG. 4 is a cross-sectional view along the line A-A of FIG. 3;

FIG. 5 is a plan view of a backboard of the device depicted in FIG. 3;

FIG. 6 is a plan view of a frame of the device depicted in FIG. 3;

FIG. 7 is a plan view of the frame depicted in FIG. 6 mounted on the backboard depicted in FIG. 5;

FIG. 8 is a plan view of the frame and backboard shown in FIG. 7 with installed sound absorbing material;

FIG. 9 is a cross-sectional view of an illustrative optically reflective sound transfer medium;

FIG. 10 is a cross-sectional view through part of an illustrative device; and

FIG. 11 is a cross-sectional view through part of another illustrative device.

### DETAILED DESCRIPTION OF PREFERRED EMBODIMENTS

A preferred embodiment of the present invention will now be described with particular reference to a configuration of the sound absorbing device as a mirror for use in a music practice room. However, it will be immediately apparent to persons skilled in the art that the teachings of the present invention have many other applications, and as such the following illustrative description should not be considered to be a limitation of the scope of the present invention. For example, as aforementioned, the teachings of the present are generally applicable to sound absorbing devices, and as such the following detailed description should not be read as limiting the scope of the present invention to a sound absorbing device that is configured as a mirror.

FIG. 1 is a schematic representation of a music practice room 1 that has a conventional mirror 3 (for example a mirrored sheet of glass mounted in a frame) hung on one wall. A musician is stood in front of the mirror 3 and is playing a trumpet 5. The bulk of the sound (denoted by the thicker solid line 7) emanating from the bell of the trumpet is directly incident on the mirror 3 and much of this directly incident sound is reflected back at the musician (denoted by the thicker dashed line 9). As the bell of the trumpet is flared, some of the sound is dispersed (denoted by the thinner solid lines 11) and is incident on the inner surface of the walls of the room to either side of the mirror, and this dispersed sound is reflected back towards the musician by the walls of the room 1.

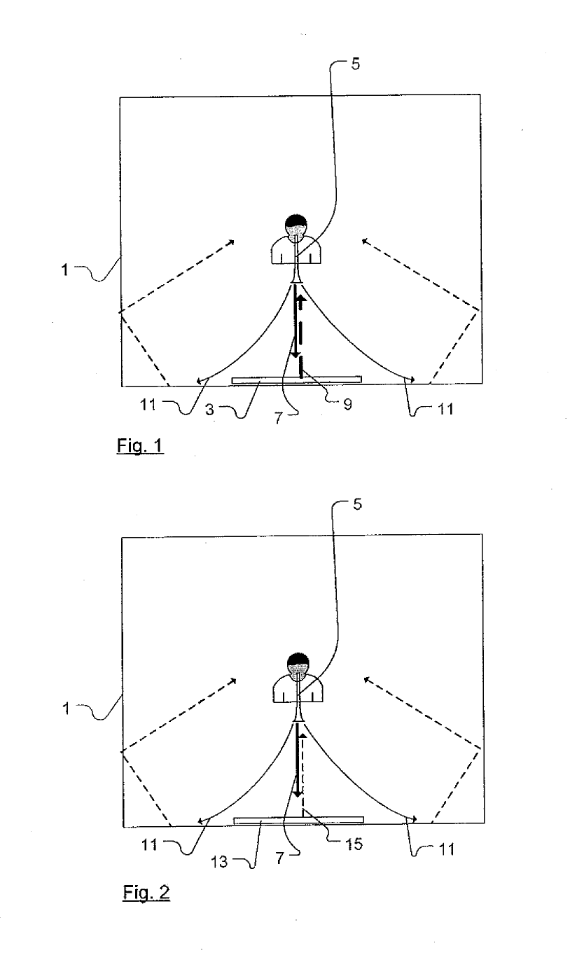

In FIG. 2, the conventional mirror 3 shown in FIG. 1 has been replaced with a sound absorbing device that is configured according to a preferred embodiment of the present invention as a mirror 13. As previously, the bulk of the sound (denoted by the thicker solid line 7) emanating from the bell of the trumpet 5 is directly incident on the mirror 13, and the remainder is dispersed (denoted by the thinner solid lines 11) to either side of the mirror 13 before being reflected back towards the musician by the walls of the room 1. However, in this arrangement much of the sound from the trumpet 5 that is directly incident on the mirror is absorbed by the mirror 13, thereby reducing the amount of sound that is reflected back at the musician (denoted by the thinner dashed line 15). The principal advantage of this arrangement, as aforementioned, is that the volume of sound to which the musician is subjected is reduced, for example by 1 to 5 dBA. An associated advantage is that this reduction in volume is achieved without disruption to the dispersed sound that provides the musician with a spatially realistic representation of the music that they are making.

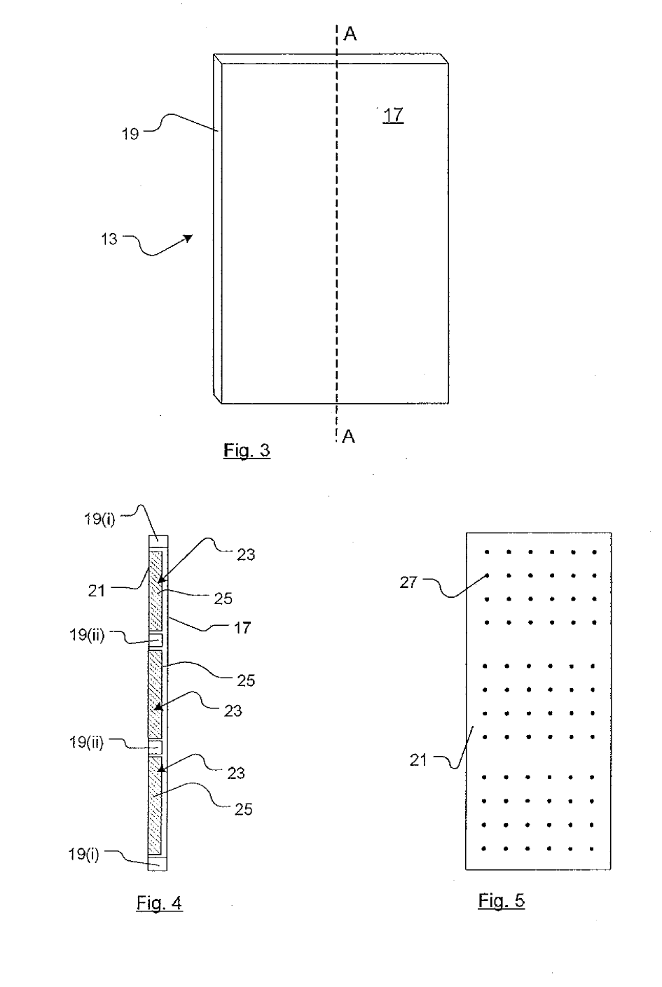

FIG. 3 is a schematic perspective view of the sound absorbing device 13 that is shown in FIG. 2 as having been installed in a music room. In this illustrative embodiment the mirror is approximately 1.94 metres long, 1.16 metres wide and 0.04 metres deep. Whilst a sound absorbing device of these proportions is preferred for this particular application, it will be appreciated by persons skilled in the art that any size of device may instead be provided.

The sound absorbing device 13 of this embodiment comprises a sound transfer medium 17 that is mounted to a frame 19 (two sides of which are visible in FIG. 1). In this embodiment the device is configured as a mirror, and as such the sound transfer medium is sufficiently optically reflective so that a person stood in front of the device can see an image of themselves in it. In a particularly preferred arrangement the sound transfer medium is at least as optically reflective as a conventional glass mirror, and in a most preferred embodiment the sound transfer medium provides substantially specular reflection. The sound transfer medium can be affixed to a front surface of the frame, or can be arranged to overlap at least part of the sides of the frame.

Referring now to FIG. 4 (which shows the sound absorbing device in section along the line A-A of FIG. 1), the device 13 comprises a backing 21 (shown in greater detail in FIG. 5) to which the frame 19 is attached. The backing, frame and sound transfer medium co-operate to define a number (in this illustrative example, three) internal voids 23 within each of which a body of sound absorbing material 25 is provided. As depicted in FIG. 4, the sound absorbing material is provided in the voids so that it is spaced from the sound transfer medium and from the frame. The spacing between the sound transfer medium and the sound absorbing material is sufficiently large to enable the sound transfer medium to vibrate in response to incident sound waves, but not so large that the device as a whole functions as a drum. A spacing of something in the order of a few millimetres, for example 1 to 5 millimetres (preferably approximately 2 millimetres) is particularly preferred.

As shown in FIG. 4, the frame 19 consists of peripheral components 19(i) that together define the periphery of the frame, and internal bracing components 19(ii) that hold the peripheral components in. As depicted, only the peripheral components 19(i) actually touch the sound transfer medium so that the sound transfer medium is free to vibrate in response to incident sound waves.

The sound absorbing material is preferably fibrous in nature. By this we mean that the sound absorbing material comprises a plurality of fibres that are intertwined to form a mass (typically of several centimetres in depth) that traps air within it. An illustrative example of a suitable sound absorbing material is rock wool (also known as stone wool). Rock wool is often used as thermal insulation in buildings, and is widely available from many suppliers. Rock wool is a so-called mineral wool, and in principle any sort of mineral wool may be used in place of rock wool. Mineral wool acts as a sound absorber because incident sound waves cause the air to move against the intertwined fibres and hence to generate a frictional force, the energy for which is taken from the incident sound waves in the form of an insignificant amount of heat. A particular advantage associated with the use of a fibrous sound absorbing material is that stray fibres upstanding from the surface of the material tend to lie against the sound transfer medium and provide a small amount of local damping of the medium as it vibrates. A small amount of this local damping is beneficial as it helps further reduce the likelihood of the sound transfer medium acting as a drum.

Referring now to FIG. 5, the backing 21 comprises a plurality of fixings 27 that are configured and arranged to protrude from the backing 21 partway into the aforementioned voids 23. The fixings 27 provide a means for securing the sound absorbing material to the backing so that it is properly located in the aforementioned voids 23. In the preferred embodiment the fixings comprise screws that are pushed through the backing so that the points of the screws are upstanding from the backing. The sound absorbing material can then be secured to the backing simply by pushing appropriately shaped portions of material onto the upstanding screws. The backing may be made of any material, but in a particularly preferred embodiment it is of wood.

Referring now to FIG. 6, of the accompanying drawings, the frame 19 of this illustrative embodiment is comprised of six lengths of material, for example wood, that have been fixed together to define (in this instance) three internal enclosures 29 that cooperate with the aforementioned backing 21 and the sound transfer medium 17 to form the voids 23 in which the sound absorbing material is located. For a sound absorbing device with the dimensions aforementioned, the peripheral components 19(i) of the frame may be made of lengths of timber that are each approximately 37 mm wide and approximately 32 mm deep (n.b.: in FIG. 6 the “width” is the dimension parallel to the plane of the paper, and the depth is the dimension perpendicular to the plane of the paper). The internal bracing components 19(ii) of the frame have a similar width, but are less deep so as to avoid touching the sound transfer medium. In embodiments of the invention where a sound transfer medium is shrunk onto the frame, it is important for the frame to be sufficiently strong to withstand the force exerted on the frame by the shrunk sound transfer medium. It is also preferred for the frame to be formed of timber that has been treated (in a conventional way) to reduce swelling or warping.

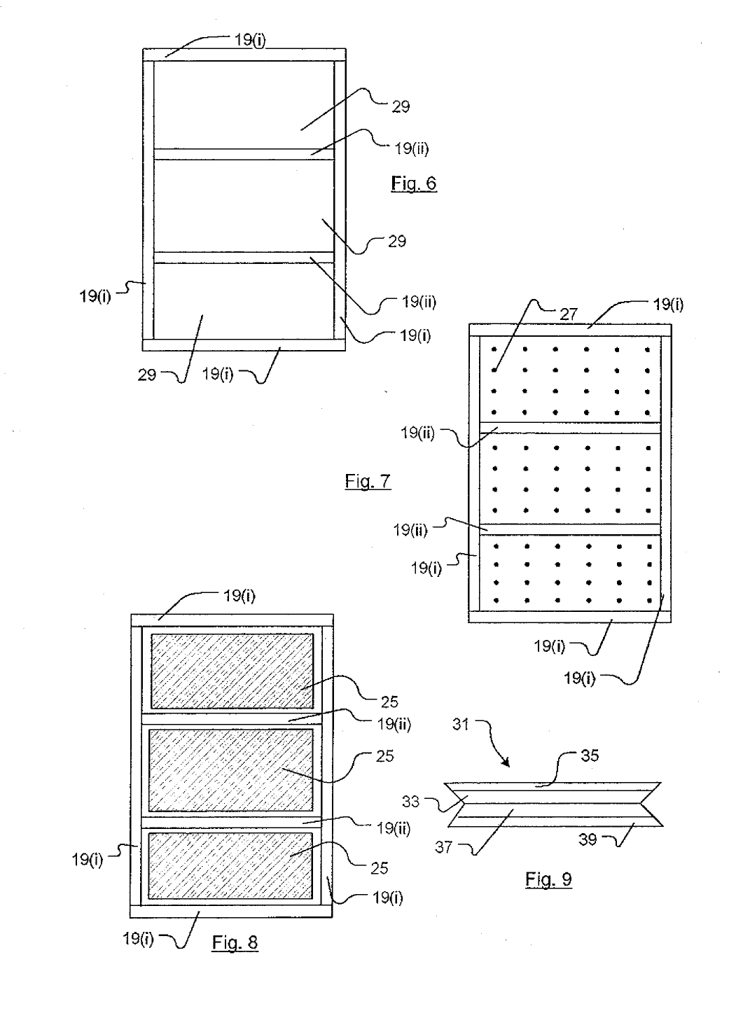

As shown in FIG. 7, the frame 19 is affixed to the backing, for example by means of screws, glue or other fixings, so that the fixings attached to the backing extend into the internal enclosures 29 of the frame. For a sound absorbing device of the dimensions aforementioned, it is preferred that the fixings extend roughly 15 to 20 millimetres into the enclosures 29.

Referring now to FIG. 8, once the frame has been attached to the backing, appropriately shaped blocks of sound absorbing material are fitted into the enclosures 29 (for example by impaling the blocks on the points of the fixings upstanding from the backing) so that the upper surface of each block is slightly recessed within the peripheral components 19(i) of the frame and the sides of each block are spaced from the frame. When the sound transfer medium is affixed to the frame, this recess will provide the spacing mentioned above. In a particularly preferred arrangement, the sound absorbing material comprises approximately 30 mm thick “Heavy Density Slab Insulation” available from Wickes (a builders merchants owned by Travis Perkins plc of Lodge Way House, Harlestone Road, Northampton NN5 7UG, United Kingdom) as product number 161189. When this material is used in a frame where the peripheral components 19(i) are 37 mm by 32 mm frame the spacing between the sound transfer medium and sound absorbing material is in the region of 2 mm or so.

Once the blocks of sound absorbing material have been affixed to the backing, the sound transfer medium can then be affixed to the frame. The sound transfer medium is relatively thin to permit it to vibrate when sound waves are incident on it, and in a preferred arrangement it is less than a hundred and fifty microns thick (i.e. the distance from one protective layer shown in FIG. 9 to the other). In a particularly preferred arrangement the sound transfer layer is less than 120 microns thick, more preferably between 60 to 100 microns thick. In general terms the sound transfer medium is of a thickness that enables it to vibrate in response to incident sound waves having a frequency of roughly 250 Hz to 2 kHz, and can be of any non-porous material that is sufficiently thin and sufficiently flexible to provide the aforementioned functionality. The sound transfer medium can be stretched over the frame to tension it for vibration in response to incident sound waves, or as is later described it may be comprise a material that is configured to shrink onto the frame—for example in response to heat.

In one envisaged embodiment the sound transfer medium, as illustrated in FIG. 9, is configured as a multilayer film 31. In this instance the film comprises a layer 33 that is at least partly optically reflective on at least one side so that the sound absorbing device functions as a mirror. It will be remembered, however, that for other applications the sound transfer medium need not be optically reflective.

The optically reflective side of the optically reflective layer 33 is covered by a peel-off protective layer 35, and the other side of the reflective layer is covered by a layer of adhesive 37 that is covered by a peel-off protective layer 39. The adhesive layer functions to secure the reflective layer 33 to the frame 19, but it will be appreciated by persons skilled in the art that any of a number of alternative (or indeed additional) fixings may be used to affix the reflective layer to the frame, and as such it may not in fact be necessary to provide a layer of adhesive (and if the layer of adhesive is not required, then the protective layer for that adhesive may also be dispensed with).

In a particularly preferred arrangement, the layer 33 that is at least partly reflective may comprise a composite metallised polymer film that is configured to shrink on the application of heat. In one illustrative embodiment, the sound transfer layer may comprise “Silver Shrink Mirror” (product number 03909 5430) supplied by Rosco International, a company trading in the United Kingdom as Roscolab Ltd., Kangley Bridge Road, Sydenham, London, SE26 5AQ, UK.

In a preferred embodiment where the sound absorbing device is configured as a mirror, the sound transfer medium is affixed to the frame by removing the protective layer 39 that covers the adhesive, applying the reflective layer to the frame 19 and allowing the adhesive to set. Once the adhesive is set, the reflective layer is heat treated (for example by baking the mirror in an oven at 150 to 200 degrees centigrade, or by playing a stream of warm air (for example from a modelling hairdryer) over the reflective layer to cause it to shrink onto the frame so that the layer is tightly stretched over the frame. In tests we have found that it is possible to provide a mirror that exhibits substantially specular reflection (i.e. a mirror that is substantially optically perfect) in this way.

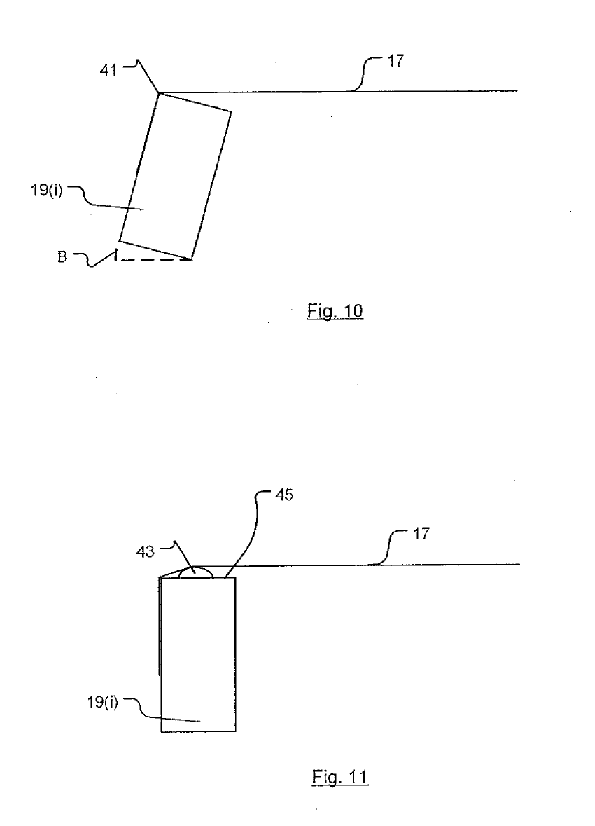

Referring now to FIGS. 10 and 11 of the accompanying drawings, it is as aforementioned preferred for the frame to be configured so that the area of frame that is in contact with the sound transfer medium is reduced. For example, as shown in FIG. 10, the peripheral components 19(i) (only one of which is shown) of the frame may be inclined towards the centre of the sound absorbing device by an angle B so that only an edge portion 41 of the peripheral components 19(i) of the frame contacts the sound absorbing structure. Angle B may be in the region of 5 to 20 degrees, preferably substantially 10 degrees. In another arrangement, depicted schematically in FIG. 11, the peripheral components 19(i) of the frame may each comprise a projection 43 (provided for example by a length of beading) that extends beyond an upper surface 45 of each of the peripheral components 19(i) of the frame (only one of which is shown in FIG. 11), and on which the sound transfer medium 17 bears. The advantage of these arrangements is that by reducing the surface area of the frame that contacts the sound transfer medium it is easier to tension the sound transfer medium on the frame. This is particularly the case where the sound transfer medium is shrunk onto the frame, because reducing the surface area that contacts the medium tends to reduce the chance of wrinkles occurring in the sound transfer medium when it is shrunk onto the frame.

As will be appreciated by persons skilled in the art, the sound transfer medium vibrates in use when sound waves, for example from an instrument, are incident on it, and the vibrating sound transfer medium generates waves that are incident upon and at least partly absorbed by the sound absorbing material located within the sound absorbing device. In this way, the device of the present invention can provide a useful reduction in ambient noise levels, for example ambient noise levels within a music practice room.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, whilst it is preferred for the sound absorbing material to be coupled to the backing by screws, it will be apparent that any means for fixing the sound absorbing material to the backing may instead be utilised. For example, the sound absorbing material could be adhered to the backing, stapled to the backing or tied to the backing.

It will also be appreciated that for those embodiments where the device is configured as a mirror, the sound transfer medium need not be inherently reflective. For example, a suitable reflective coating could be applied to a non-reflective film that has been stretched over the frame by any of a number of different coating processes that are each well known in the art.

It is also conceivable that the protective layer 35 need not be a peel-off film, but could instead comprise a protective layer that is consumed during the heating process. This arrangement would be advantageous in that it would provide an easy means for determining whether the mirror has been heated sufficiently, and in that it would protect the reflective layer right up to the point where assembly of the mirror has been completed.

As an illustration of other possible applications, it is conceivable that the present invention could usefully be employed in bars and clubs where noise levels are likely to be significant and employers will have a duty to their employees to ensure that they are not subject to potentially damaging sound levels in the course of their employment. In this application, the provision of sound absorbing devices (which may or may not be reflective) would help reduce ambient noise levels within the bar or club. Similarly, the teachings of the present invention may also find application in gyms, for example in dance studios of such establishments. In such establishments it is typical for music to be played at high volume in relatively highly reverberant rooms, thus affecting speech and music intelligibility. In such applications it is commonplace to acoustically treat the ceiling of the room, but in such an approach much of the sound is trapped between the reflective walls and hence the absorption is not effectively utilised. By providing a sound reducing device according to the teachings of the present invention (which may or may not be mirrored), such problems can be avoided or at least mitigated.

Lastly, it should also be noted that whilst the accompanying claims set out particular combinations of features described herein, the scope of the present invention is not limited to the particular combinations hereafter claimed, but instead extends to encompass any combination of features herein disclosed.

1.-25. (canceled)

26. A sound absorbing mirror comprising:
a frame;
a backing attached to the frame;
a sound absorber coupled to the backing, and
a mirrored sound transfer medium that is: a) spaced from the sound absorber; and b) configured and arranged to transfer sound waves incident on the sound transfer medium to the sound absorber for absorption thereby.

27. A sound absorbing mirror according to claim 26, wherein the sound transfer medium is configured to vibrate in response to incident sound waves.

28. A sound absorbing mirror according to claim 26, wherein the sound transfer medium is configured to be responsive to sound waves having a frequency of 250 Hz to 2 kHz.

29. A sound absorbing mirror according to claim 26, wherein the sound absorber comprises fibrous sound absorbing material.

30. A sound absorbing mirror according to claim 29, wherein the fibrous sound absorber material comprises a body consisting of a plurality of intertwined fibres.

31. A sound absorbing mirror according to claim 30, wherein said sound absorber material comprises a mineral wool.

32. A sound absorbing mirror according to claim 31, wherein the mineral wool comprises rock wool.

33. A sound absorbing mirror according to claim 26, wherein the sound absorber and sound transfer medium are spaced from one another by about 1 to 5 mm.

34. A sound absorbing mirror according to claim 29, wherein the fibrous sound absorbing material has a generally planar surface, and a spacing between the sound absorber and sound transfer medium is such that at least some fibres that are upstanding from said generally planar surface bear against the sound transfer medium to locally damp vibrations in said medium.

35. A sound absorbing mirror according to claim 26, wherein the frame supports said sound transfer medium.

36. A sound absorbing mirror according to claim 26, wherein the backing comprises a support for the sound absorber.

37. A sound absorbing mirror according to claim 36, wherein said support comprises a plurality of fixings extending from a face of the backing, and the sound absorber can be is impaled on the fixings, to thereby affixing the sound absorber structure to the backing.

38. A sound absorbing mirror according to claim 36, wherein the frame and backing are configured and arranged so that the sound absorber supported by the backing is spaced from the sound transfer medium affixed to the frame by about 1 to 5 mm when the backing is secured to the frame.

39. A sound absorbing mirror according to claim 26, wherein the mirrored sound transfer medium comprises a non-porous tensioned film.

40. A sound absorbing minor according to claim 39, wherein the film is less than 150 microns thick.

41. A sound absorbing mirror according to claim 39, wherein the film is shrinkable to tension the film.

42. A sound absorbing mirror according to claim 41, wherein the film is shrinkable in response to heat at a temperature of 100 to 150 degrees centigrade.

43. A sound absorbing mirror reflective sound absorbing device comprising:
a backing that comprises a support for a sound absorber;
a sound absorber structure mounted on said support;
a frame affixed to the backing; and
a mirrored non-porous optically reflective tensioned film that is tensioned and is carried by the frame;
wherein the frame is configured to provide a space between the film and the sound absorber structure of about 1 to 5 mm, and the film is configured to transfer sound waves incident on the film to the sound absorber for absorption thereby.
